(19) United States
(12) Patent Application Publication
(10) Pub. No.: US 2006/0156653 A1
(43) Pub. Date: Jul. 20, 2006

(54) Window conversion unit

(76) Inventor: David Engebretson, Gig Harbor, WA (US)

Correspondence Address: MICHAEL J. BERGNACH, 822 SHERIDAN ROAD, KENOSHA, WI, 53140, US

(21) Appl. No.: 11/036,161

(22) Filed: Jan. 14, 2005

(51) Int. Cl. E06B 3/00

(52) U.S. Cl. 52/204.5

(57) ABSTRACT

A window conversion unit that replaces an existing window panel in an existing window panel frame or sash. The window conversion unit has at least one panel. The panel or panels are supported within the existing panel frame or sash by a replacement frame configured to support the panels. The replacement frame includes a conversion portion configured to engage the existing window panel frame.

### BACKGROUND OF THE INVENTION

The present invention relates, in general, to window replacement systems and, more specifically, to a window conversion unit that provides for the replacement of an existing window panel with a different panel or panels and that has a frame structure configured to engage the existing window panel frame or sash. The present invention also relates to a window conversion unit having at least one panel configured as a pet door.

Existing window structures present many problems to users, because of their lack of versatility and adaptability. Since windows are permanently fixed to the building structure during construction, they cannot be removed without significant deconstruction of the window structure—that is, removing the window structure down to the rough opening of the building structure. Also, windows are not designed to change their configuration during their useful life. Further, most windows are not made from standardized parts between window manufacturers. Even within the product line of a window manufacturer, sizes and configurations can differ substantially. Therefore, changing the style or function of a window, or upgrading a window panel with a standard part is very difficult.

Window structures also pose a constant difficultly of maintaining a weatherproof barrier and preventing air leakage through the window structure. Since the windows are a break in the building structure and have many joints and parts, some of which may move, they provide many opportunities for leakage between the outdoor and indoor atmospheres. These leaks lead to inefficiency in homes and wasted money and energy. Further, like many building entryways, but perhaps more the case for windows, and especially for sliding patio doors, window structures also present a less secure barrier for unwanted entrants than other more fixed and rigid parts of a building. For older windows that may have older technology, they possibly can be less weatherproof and less airtight, and even less secure than current window products. As the size of the window structure increases, these problems can become magnified. Also, windows with added functionality, such as sliding action or door-like function, can increase these inherent window problems. Therefore, window structures, like sliding patio doors among others, require extra precautions to mitigate these problems. Despite these inherent problems of window structures, they are an essential structural element to a building, providing light and possibly air circulation to the interior, allowing users to view the outdoors, and giving a building aesthetic appeal.

Therefore, a need exists to make existing window structures more versatile and changeable or upgradeable, while maintaining their function, appearance, and providing a barrier that seals the building from the outdoors. Also, a need exists for making the task of replacing window panels easier and less costly. Further, a need exists for a device that can adapt windows, such that more function can be given to a window.

Generally well-known in related art are integrated replacement windows systems configured to replace existing windows structures down to the existing window frame without removing the existing window frame down to the rough opening of the building structure. These systems generally include a supplementary, replacement window frame that fits within the opening of the existing window frame. These systems still require a significant amount of deconstruction of the window structure for installation. The existing sash (window panel frame or pane frame) and its support structure must all be removed, so that the replacement window frame can be installed in this space. Further, great consideration, possibly requiring that of an experienced technician or carpenter, must be given to ensure the proper fit and seal of the replacement window within the existing window frame. Although typically done, it is difficult to accurately measure the dimensions of an existing window frame without removing the sashes first. Window frames also vary in configuration, and old frames may no longer be perfectly square, factors that add to the difficulty of properly sealing a replacement window frame inside an existing window frame.

Also known in related art are adaptive window systems for upgrading existing window structures, in which an additional window pane is applied to an existing window pane within the existing window sash. A complete, fully integrated window panel cannot by be manufactured off-site to higher quality standards of strength, clarity, and a tight seal for this type of system. The existing and new panels may not conform to each other. Insulating gases, common among current window glazings, also cannot be applied between the panels of this type of system. Because adaptive systems leave the existing window panel, they do not fit exactly within the sash and may have a poor finish or appearance. Lastly, additional functions could be restricted by this type of system, because the existing panel is not removed.

Lastly, there also exists, in related art, sliding patio door systems that add the function of a pet door to the window structure. Insertable patio door panels, which include pet doors, are installed within the window frame in addition to existing patio doors- that is, without removing them. These insertable panels decrease other functions of the patio door and decrease the physical integrity of the patio door structure. This system increases the edges to seal and to lock making it less insulating and less secure. Also, because these parts are not original mating parts, they may have a poor fit with the abutting window frame and sliding vent door. Further, the sliding patio door can no longer seal tightly to prevent air leakage or unwanted entrants, because the sliding vent door can no longer completely travel and fully shut. Originally, the sliding vent door would seal at both the sealing end, which engages the fixed patio door, and the locking end, which locks to the frame. Further, more obstacles block the view and entryway in the system: the insertable pet door partially blocks the opening of the sliding vent door, and the sealing, vertical stile of the sliding vent door, which is now partially open, interferes with the view of the fixed patio door. Lastly, the insertable pet door may not exactly aesthetically match the original patio door frame and, thus, look unappealing.

Sliding vent doors in the related art of patio door systems may also be cut to install the addition function of a pet door into the cut-out portion. That is, the original piece of glass may be cut to install a panel within the cut-out space. This configuration has the obvious problem of the window panel losing its physical integrity or the original factory seal, especially in a multiple glazed panel that contained gas for insulation. Again, this type of system most likely requires much attention, possibly from an experienced technician, to ensure a proper seal. It would also be difficult to manufacture this type of system off-site to higher quality standards.

Attached is a information disclosure statement and several patents that relate to the some of the above-mentioned concepts.

### BRIEF SUMMARY OF THE INVENTION

The above-listed needs are met or exceeded by the present window conversion unit. The present window conversion unit provides a system for replacing an existing window panel, which could be a single-pane glazing, multiple-pane glazing, or other type of panel, with a different, replacement panel or panels without replacing or removing the existing sash (the existing window panel frame). The present invention can be installed in a large variety of window structures. The replacement panel or panels may have physical advantages over the existing window panel, offer the user more functionality, or simply replace a broken or defective existing window panel.

More specifically, the present window conversion unit has at least one panel. The panel or panels are supported within the existing window panel frame or sash by a replacement frame configured to support the panels. The replacement frame includes a conversion portion configured to engage the existing sash or panel frame.

The present window conversion unit can be configured for many types of windows of various sizes and styles and from various manufactures without having to perform significant deconstruction or modification of the window structure. The replacement frame of the present invention engages the interior of the existing sash, which supports the periphery of the window conversion unit. The conversion portion is configurable in the replacement frame to have the same dimensions of height, width, and thickness of the existing window panel that is being replaced. Therefore, only the inside of dimensions of the sash are required to ensure a proper fit, and just minor deconstruction of the sash is required to install the window conversion unit. There is nothing in the prior art that relates to a system for universally mounting a window panel having a frame using a mounting conversion portion or stub that fits inside an existing sash or window panel frame.

The present window conversion unit saves time and money by being configured to engage an existing sash. It is installed without replacing the whole window frame or, as typical replacement windows require, replacing the interior window panel frames or sashes. The savings are obvious in comparison to replacing the whole window frame down to the rough opening of the building structure, where more material and more specialized labor, like a carpenter, may be required. Even typical replacement windows require more material adding to cost, and they may require significant adjustment by a professional technician to fit and seal within different openings.

Further, since the replacement panel frame is configured to engage the sash, it can provide a tight seal to prevent air leakage. The remainder of the original window structure from the sash to the window frame stays intact. This preserves the various other joints and connections of the original structure and can further mitigate the possibility of air leakage from poor fit or improper seal at the joints.

Similarly, no additional locking devices are required with the conversion unit, keeping the window structure more secure. Since the window conversion unit uses the exiting sash, all existing locking mechanisms stay intact. This ensures a proper fit and function between engaging lock parts. This also keeps the number of locking points the same, reducing the chances that additional locks may not be engaged properly and, thus, insecure.

Additional functionality can be added to the window conversion unit while maintaining an attractive appearance and the inherent functions of the window structure. A pet door product, like those commonly available in the marketplace, can be added as one or more of the panels of the conversion unit without having to modify the window frame or sash. Further, no additional framework outside of the sashes or window panel frames is required that may interfere with the sashes or the inherent function of the window structure. Therefore, a pet door panel or other functional panel can be added to the conversion unit while maintaining a substantial viewing area by reducing obstructions, and allowing the sashes to maintain their original movement and fit within the window frame. Also, by eliminating obstructions outside of the sashes, the vent opening is clear space, and moving sashes can operated as originally configured. There is nothing in the prior art that relates to a system for mounting different types of window panels inside of a frame that can be mounted and fit inside an existing sash or window panel frame.

The present invention can also provide a nice and uniform appearance and help to maintain the appearance of the existing window structure. It can be manufactured off-site at a factory to ensure high standards for construction, finish, clarity, strength, and good seal. Manufacturing off-site also allows window panels of the window conversion unit to be sealed having an insulting gas between multiple panes of the same panel.

### BRIEF DESCRIPTION OF THE DRAWINGS

FIG. 1 is a front view of the preferred embodiment of the present window conversion unit shown before installation;

FIG. 2 is a top view of the preferred embodiment of the present window conversion unit show before installation;

FIG. 3 is a side view, in section, of the preferred embodiment installed within a sash taken on section lines 3-3 of FIG. 1;

FIG. 4 is a side view, in section, of the preferred embodiment taken on section lines 4-4 of FIG. 1;

FIG. 5 is a front view of another embodiment of the present window conversion unit shown before installation;

FIG. 6 is a side view, in section, of another embodiment installed within a sash taken on section lines 3-3 of FIG. 5; and

FIG. 7 is a side view, in section, of another embodiment taken on section lines 4-4 of FIG. 1.

### DETAILED DESCRIPTION OF THE INVENTION

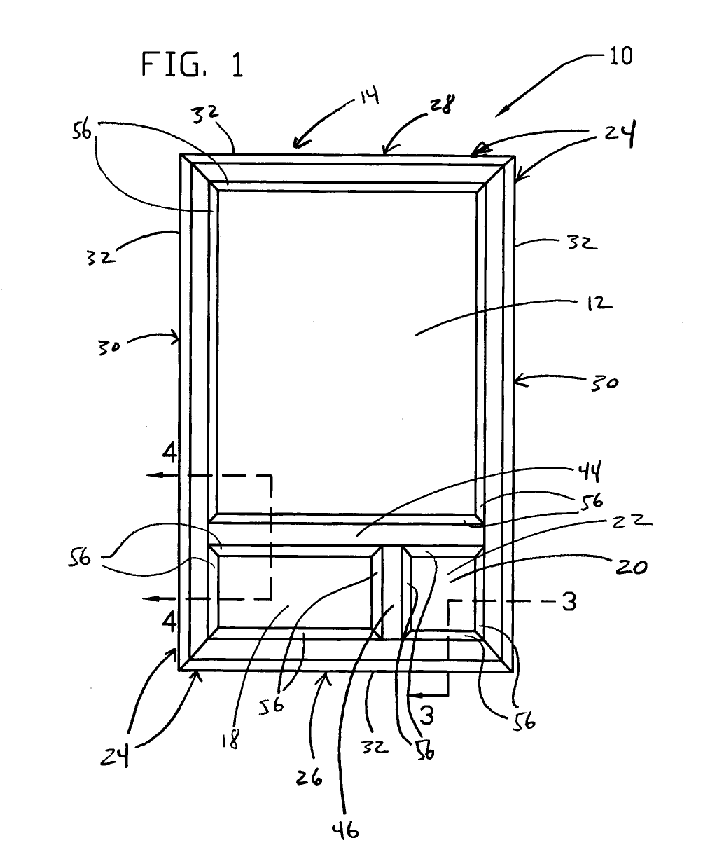

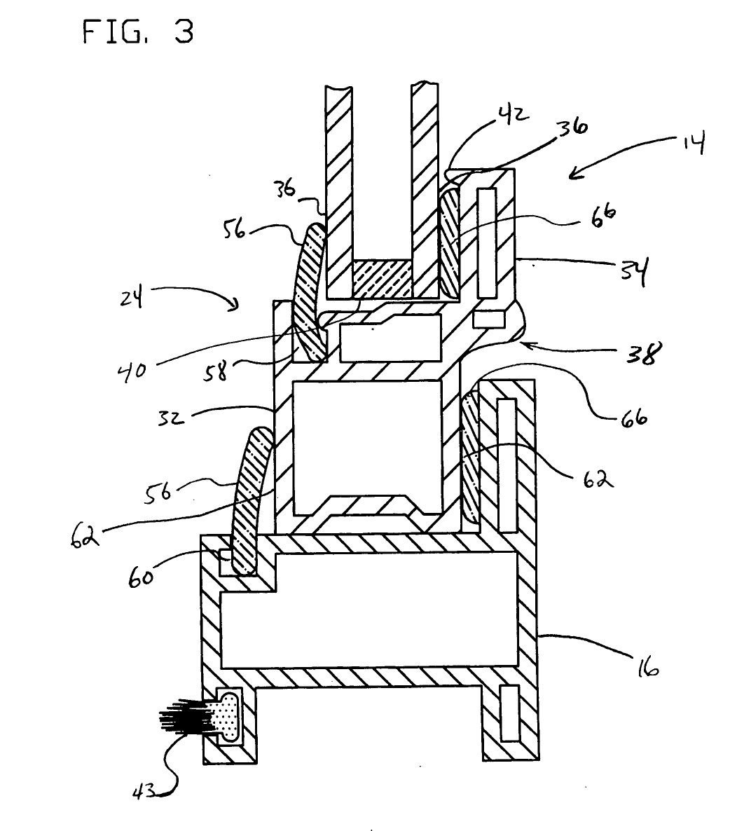

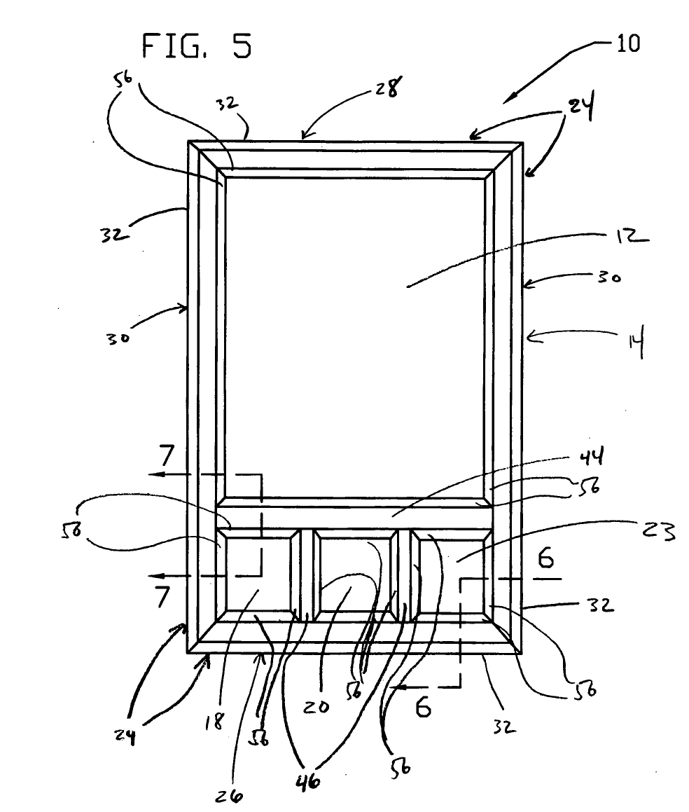

Referring now to FIGS. 1-5, a preferred embodiment of the present window conversion unit is generally designated 10. As shown in FIG. 1, the unit includes a first panel 12 and a replacement frame 14 configured to support the first panel within an existing window panel frame 16 (also called a sash), which is best shown in cross-section in FIG. 3. Further shown in FIG. 1, the replacement frame 14 preferably also supports a second panel 18 and a third panel 20, which, in the preferred embodiment, is a pet door unit 22, commonly available in the marketplace. This multiple panel configuration supportable within the replacement frame gives a window structure versatility, adaptability and additional functionality, because differently sized panels, panels with different physical properties, and panels having different functional abilities are supportable and installable within the replacement frame 14. Further, while not shown in the preferred embodiment, this invention conceives that more than three panels are supportable and installable within the replacement frame 14. FIG. 5 depicts another embodiment of the present invention having a forth panel 23.

In the preferred embodiment, the replacement frame 14 includes four frame members 24, as shown in FIG. 1. Frame members 24 are configured to be securely attached at their ends to other frame members 24. In the preferred embodiment, the frame members 24 are arranged in a rectilinear configuration, a bottom frame member 26 and a top frame member 28 are positioned in a straight, parallel, horizontal arrangement, and a two side frame members 30 are positioned in a straight, parallel, vertical arrangement. The ends of the bottom frame member 26 and of top frame member 28 are connected to opposite ends of the side frame members 30, as shown in FIG. 1. While this configuration may be the most practical based on the popularity of rectilinear windows, other configurations are conceived, which may require more than four frame members or frame members configured in different arrangements or shapes to accommodate differently shaped existing window panel frames. Frame members in other embodiments may have curved shapes or polygonal configurations.

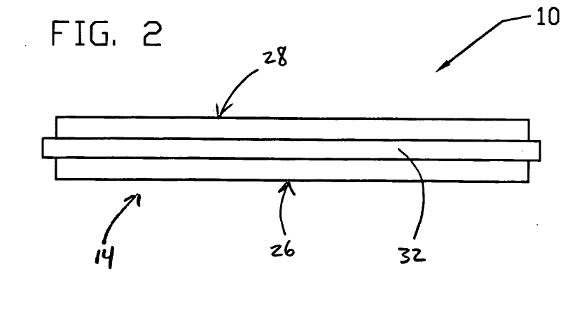

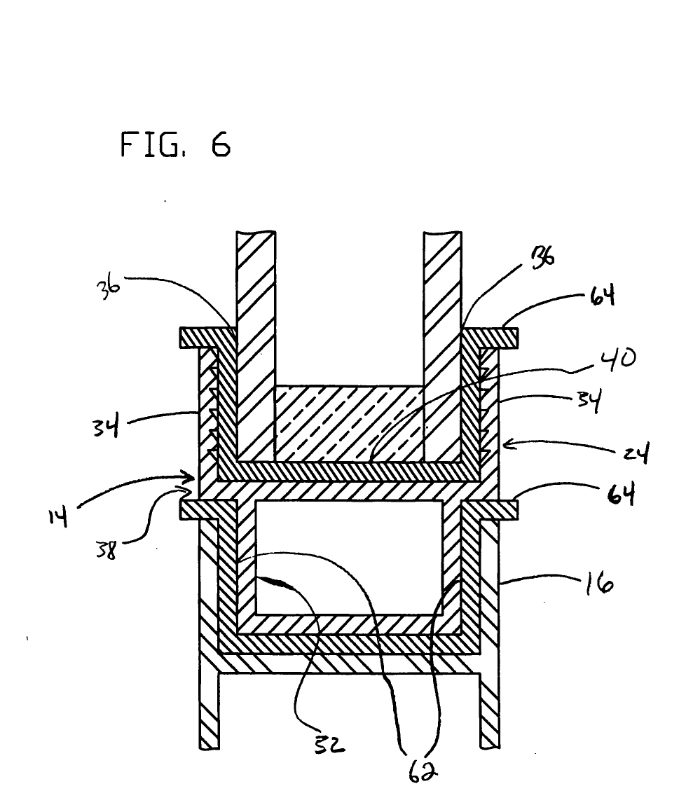

Further shown in FIGS. 1 and 2, the replacement frame 14 has a conversion portion 32 along the periphery. As best shown in FIG. 3, the conversion portion 32 is configured to engage an existing window panel frame 16. While FIG. 3 shows a cross-section of the bottom frame member 26, it represents the cross-sections of all of the frame members in the preferred embodiment. During replacement, an existing window panel, which is not shown, is removed from the existing window panel frame 16. The conversion portion 32, as shown in FIG. 3, fits into the vacant space remaining after the removal of the existing window panel. Thus, the conversion portion 32 is supportable by the structure of the existing window panel frame 16. The conversion portion 32 is configurable to engage a space of various sizes in the existing window panel frame from the evacuation of various existing window panels. Another embodiment of the present invention in FIG. 6 shows the conversion portion 32 configured to fit and be supported by a different size and type of existing window frame panel 16. While FIG. 6 shows a cross-section of the bottom frame member 26, it represents the cross-sections of all of the frame members in another embodiment. Therefore, the replacement frame 14 is configurable to engage different existing window panel frames 16 having various dimensions. The window conversion unit 10 can, hence, properly fit many window structures without having to deconstruct much of the structure, by being configurable in the replacement frame 14 to match the height, width, and depths dimensions of the existing window panel. Also, because much of the original window structure, including locking devices, is maintained, there is close engagement between the window conversion unit 10 and the existing window structure, this unit maintains a high quality barrier from the elements outside of the building.

As best shown in FIG. 3, the replacement frame 14 of the preferred embodiment includes a transverse support 34 that extends inward from the replacement frame 14 to support a window panel face 36 along a section near the periphery. Also in the preferred embodiment, a frame member mid-section 38 supports the peripheral edges 40 of a window panel. Further in the preferring embodiment, sealing lips 42 extend from the transverse support 34 to help maintain a seal for a window panel. In another embodiment, as shown in FIG. 6, the transverse supports 34 extend inward from the replacement frame 14 to support both window panel faces 36 along sections near the periphery. Additionally, the current invention conceives that at least one transverse support extends inward from the replacement frame 14 and is configured to support at least one face of a window panel along a section near the periphery of the window panel. Further shown in FIG. 3 is an existing weatherstripping piece 43.

A lateral cross-member 44 is preferably connected at its ends to opposite sides members 30, as shown in FIG. 1, and configured to support the bottom of the first panel 12 and the tops of the second panel 18 and the third panel 20 within the replacement frame 14. A longitudinal cross-member 46 supports the sides of the second panel 18 and third panel 20 and is connected at its ends to the lateral cross-member 44 and to the bottom frame member 26, also as shown in FIG. 1. Depending upon the number of panels configured within the replacement frame 14 in other embodiments of this unit, this invention further conceives that at least one lateral cross member and at least one longitudinal cross-member are configurable to the replacement frame 14 to support panels. FIG. 5 shows another embodiment of the present invention having a two longitudinal cross-members 46 that support the sides of the second panel 18, the third panel 20, and the forth panel 23, and the lateral cross-member 44 supporting four panels.

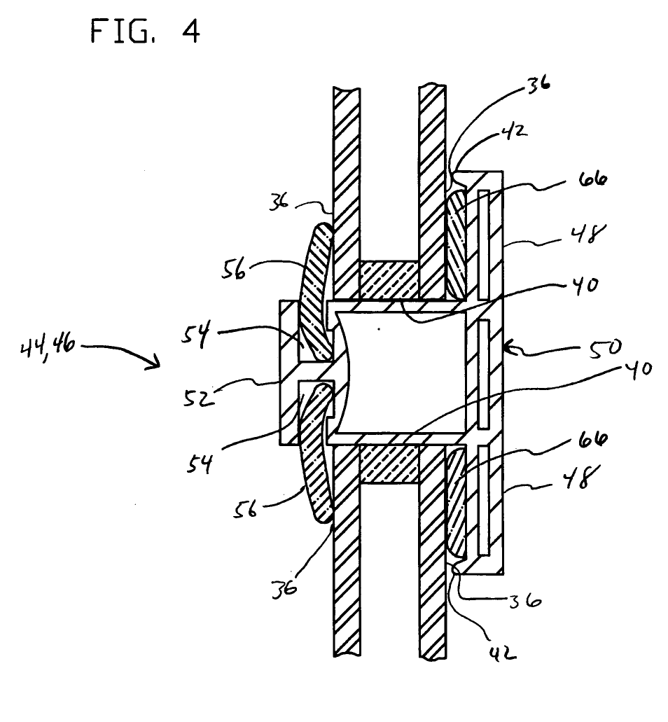

FIG. 4 shows the cross-section of the preferred embodiment of the lateral cross-members 44. FIG. 4 also represents the cross-section of the preferred embodiment of the longitudinal cross-members 46. Cross-member support portions 48 extend in opposite directions from a mid-section 50 of the cross-member to support the window panel face 36 near the periphery of the window panel. Sealing lips 42, as best shown in FIG. 4, are configured at the distal ends of the cross-member support portions 48. The mid-section 50 of the cross-member supports the peripheral edges 40 of the window panel. An outside T-member 52 in the preferred embodiment extending laterally from the mid-section 50 creates cross-member seal slots 54 on opposite sides of the T-member 52, as shown in FIG. 4.

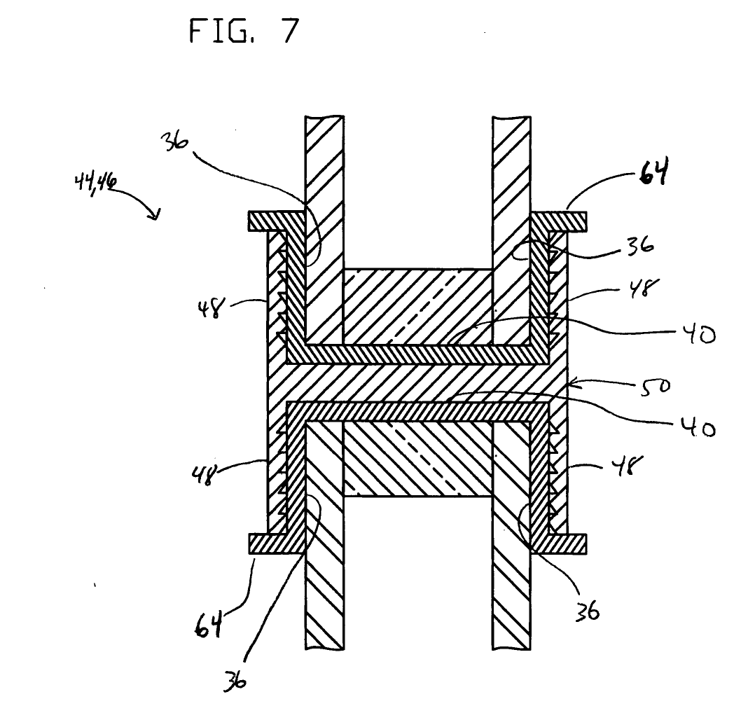

A means for sealing in the present invention is configured to support, protect, and seal panels within the replacement frame and to support, protect, and seal the replacement frame within the existing window panel frame. The means for sealing in the present invention can be stop seal pieces, beads of caulk, and vinyl boots. In the preferred embodiment, as shown in FIG. 3, a stop seal piece 56 fits within a replacement frame seal slot 58 and abuts the window panel face 36 along a section near the periphery. Also, in FIG. 3, a stop seal piece 56 also fits within an existing window panel frame seal slot 60 and abuts a side face 62 of the conversion portion 32. Further, in FIG. 4, stop seal pieces 56 fit within the cross-member seal slots 54. Alternatively, the stop seal pieces 56 may also be beads of caulk. In another embodiment, as best shown in FIGS. 6 and 7, a vinyl boot 64 that surrounds the peripheral edges of panels and surrounds the peripheral edges of the conversion portion 32 to support, protect, and seal panels within the replacement frame 14 and to support, protect, and seal the conversion portion 32 within the existing window panel frame 16.

Also, as shown in FIGS. 3 and 4, glazing support pieces 66 adhere on one side to the transverse supports 34 of the replacement frame 14 or to cross-member support portions 48 and, on the opposite side, to the window panel faces 36. The glazing support pieces also adhere to inside of the back of the existing window panel frame 16 on one side and, on the opposite side, to the side face of the conversion portion 62. The glazing support pieces 66 secure the panel the transverse supports 34 and cross-member support portions 48, and thus, to the replacement frame 14 and the cross-members. The glazing support pieces 66 are configured to support, protect, and seal a panel within the replacement frame 14, and support, protect, and seal the replacement frame 14 within the existing window panel frame 16, as depicted in FIG. 3. The sealing lips 42, in FIGS. 3 and 4, are configured to conceal the glazing support pieces 66 and provide a more attractive appearance.

A means for joining, commonly known to those in the art, connects the members of the replacement frame. The means for joining frame members may include screws and screw holes, welded joints, glue, and rivets, among other ways known to those in the art. The members of the replacement frame are configured such that they can be produced through commonly available manufacturing processes and may be mass produced. Producing the members in this way can increase the speed of production and improve their quality. Therefore, mating parts can fit together more precisely and improve ability of the window conversion unit to maintain a weatherproof barrier and an airtight seal.

While various embodiments of the present invention have been shown and described, it should be understood that other modifications, substitutions, and alternatives are apparent to one of ordinary skill in the art. Such modifications, substitutions, and alternatives can be made without departing from the spirit and scope of the invention, which should be determined from the appended claims. The general shape of window conversion unit 10 may vary in size and proportions to achieve the best engagement with sashes or window panel frames having varying dimensions. Panels in the window conversion unit 10 made include multiple panes that are sealed with an insulting gas inside, between the different panes. Further, the parts of the window conversion unit can be joined in various ways that are apparent to one of ordinary skill in the art. Also, the parts of the window conversion unit can be configured to be mass produced by processes well-known and apparent to one of ordinary skill in the art. Lastly, it should be understood that the present window conversion unit may be made out of various materials, such as plastic, wood, steel, and other capable materials, and their derivatives, such as vinyl and aluminum.

What is claimed is:

1. A window conversion unit for replacing an existing window panel in an existing window panel frame or sash, comprising:
a) a first panel;
b) a replacement frame configured to support said first panel within the existing window panel frame; and
c) said replacement frame having a conversion portion configured to engage the existing window panel frame.

2. A window conversion unit as defined in claim 1, wherein said replacement frame is configurable to engage different existing window panel frames having various dimensions.

3. A window conversion unit as defined in claim 1, wherein said conversion portion is configurable to engage a space of various sizes in the existing window panel frame from the evacuation of the existing window panel.

4. A window conversion unit as defined in claim 1, wherein said conversion portion is configurable in said replacement frame to match the peripheral height, width, and thickness of the existing window panel that is being replaced.

5. A window conversion unit as defined in claim 1, wherein said replacement frame further comprises:
a) at least four frame members.

6. A window conversion unit as defined in claim 1, wherein said replacement frame further comprises:
at least one transverse support extending inward from the replacement frame and configured to support a face of a window panel along a section near the periphery of the window panel.

7. The window conversion unit as defined in claim 1, further comprising:
a) a second panel; and
b) at least one cross-member configured within said replacement frame to support panels within said replacement frame.

8. The window conversion unit as defined in claim 7, wherein said second panel further comprises a pet door.

9. The window conversion unit as defined in claim 7, further comprising:
a) a third panel.

10. The window conversion unit as defined in claim 9, wherein at least one of said panels may comprise a pet door.

11. The window conversion unit as defined in claim 9, further comprising:
a) a forth panel.

12. The window conversion unit as defined in claim 11, wherein at least one of said panels may comprise a pet door.

13. A window conversion unit as defined in claim 1, further comprising a means for sealing configured to support, protect, and seal panels within the replacement frame and to support, protect, and seal the replacement frame within the existing window panel frame.

14. A window conversion unit as defined in claim 13, wherein said means for sealing is a stop support piece, a bead of caulk, and a vinyl boot.

15. A window conversion unit as defined in claim 1, having glazing support pieces configured to support, protect, and seal panels within the replacement frame and to support, protect, and seal the replacement frame within the existing window panel frame.

16. A window conversion unit for replacing an existing window panel in an existing window panel frame or sash, comprising:
a) at least three panels;
b) a replacement frame configured to support said at least three panels within the existing window panel frame;
c) said replacement frame having a conversion portion configured to engage the existing window panel frame;
d) said replacement frame having at least four frame members;
e) said replacement frame having at least one transverse support extending inward from the replacement frame and configured to support a face of a window panel along a section near the periphery of the window panel;
f) at least one cross-member configured within said replacement frame to support panels;
g) wherein at least one of said three panels is configured as a pet door;
h) a means for sealing configured to support, protect, and seal panels within the replacement frame and to support, protect, and seal the replacement frame within the existing window panel frame;
i) wherein said means for sealing panels can include a stop seal, a bead of caulk, and a vinyl boot; and
j) having glazing support pieces configured to support, protect, and seal panels within the replacement frame and to support, protect, and seal the replacement frame within the existing window panel frame.

17. A method of replacing a window panel, whereby an existing window panel within an existing window panel frame is replaced with a different, replacement frame, whereby the replacement frame is configured to be supported within the existing window panel frame.

18. A method of replacing a window panel as defined in claim 17, whereby the replacement frame matches the peripheral height, width, and thickness dimensions of the existing window panel.

19. A method of replacing a window panel as defined in claim 17, whereby at least one different panel is installed within the replacement frame.
